(19) United States
(12) Patent Application Publication
(10) Pub. No.: US 2005/0126842 A1
(43) Pub. Date: Jun. 16, 2005

(54) Methodology for the design and manufacture of a family of recreational vehicles and the vehicles designed and manufactured according to that methodology

(76) Inventors: Mihai Rasidescu, Sherbrooke (CA); Roger Rioux, Magog (CA); Denis Morin, Valcourt (CA)

Correspondence Address: BOMBARDIER RECREATIONAL PRODUCTS INC;INTELLECTUAL PROPERTY DEPT, PO BOX 230, NORTON, VT, 05907-0230, US

(21) Appl. No.: 10/731,933

(22) Filed: Dec. 11, 2003

(51) Int. Cl. B60K 1/00

(52) U.S. Cl. 180/291

(57) ABSTRACT

The present invention concerns a methodology for designing and manufacturing one from a family of vehicles. The family includes a first land vehicle including one of a motorcycle, a snowmobile, and an all terrain vehicle. The first land vehicle has a V-type engine and a first transmission operatively connected to the V-type engine. The first transmission is a separate component from the engine. The family also includes a second land vehicle including one of a motorcycle, a snowmobile, and an all terrain vehicle. The second land vehicle has the V-type engine and a second transmission operatively connected to the engine. The second transmission is a separate component from the engine. In addition, the second land vehicle is any land vehicle other than that selected for the first land vehicle. Alternatively, the second land vehicle is one of a personal watercraft, a boat with an inboard engine, and a boat with an outboard engine.

This application claims the benefit of priority to U.S. Provisional Patent Application Ser. No. 60/431,244 entitled “A METHODOLOGY FOR THE DESIGN AND MANUFACTURE OF A FAMILY OF RECREATIONAL VEHICLES AND THE VEHICLES DESIGNED AND MANUFACTURED ACCORDING TO THAT METHODOLOGY” which was filed on Dec. 6, 2002 the contents of which are incorporated herein by reference.

### BACKGROUND OF THE INVENTION

1. Field of the Invention

The present invention concerns a methodology for designing and constructing a family of recreational vehicles and the vehicles constructed according to that methodology. In particular, the present invention minimizes duplicative effort expended during the design and manufacture of two or more different individual vehicles within a family of recreational vehicles

2. Description of the Related Art

Recreational vehicles encompass a wide variety of vehicle types including motorcycles, all terrain vehicles (ATVs), personal watercraft (PWCs), boats with inboard engines, boats with outboard engines, and snowmobiles, among others.

Because these vehicle types are so different from each other, it has been the traditional practice to design and manufacture vehicle models within a particular vehicle type by focusing on the similarities between various vehicle models within the vehicle type. According to this approach, successful advances incorporated into one vehicle model may be adapted readily to another vehicle model within the vehicle type. For example, when designing two models of an ATV, an advance for one ATV may be adapted for use on another ATV, especially because the two vehicles have similar, basic requirements for their construction and operation.

Even though those skilled in the art may recognize the inherent efficiency in taking a common approach to the design and manufacturing of different vehicle models within a vehicle type, certain inefficient design and manufacturing approaches remain very much the standard, even today. For example, it is common to design a new engine or series of engines for different vehicle models within a vehicle type. The reason for this is simple.

Each new vehicle model presents new design and manufacturing challenges that must be overcome before the vehicle may be introduced into the market. For example, the weight of the vehicle should be distributed so that the vehicle operates in an acceptable manner. Moreover, the engine for the vehicle should be designed to generate acceptable propulsive power so that the engine will perform in an expected manner when installed in the frame of the vehicle.

With respect to the design and manufacturing of an engine for a particular vehicle model within a vehicle type, it is not uncommon to design and manufacture the engine so that the engine incorporates a transmission into its structure. When built in this manner, the construction of the vehicle is simplified because there are fewer components that must be attached to the vehicle frame.

In the case of a motorcycle, the engine operationally connects to the rear wheel of the vehicle via an endless connector such as a chain or belt. So that the engine's power may be transmitted smoothly to the rear wheel throughout the operational range of the vehicle, the power is channeled through a geared transmission. The geared transmission typically operates as a five-speed, manual, clutch-controlled transmission. According to standard practice, the engine's transmission typically is designed as an integral part of the engine.

In the case of ATVs, as another example, the engine is connected to the wheels of the vehicle typically by an endless connector such as a chain or a drive shaft. So that the engine's power may be transmitted to the wheels smoothly over the engine's operational range, the motive force typically is transmitted either through a geared transmission (also referred to as a “gearbox”) or through a continuously variable transmission (commonly referred to as a “CVT”). As with the engine for a motorcycle, the geared transmission or the CVT usually is manufactured as an integral part of the engine itself.

In the case of a snowmobile, the engine typically connects to the endless track beneath the rear of the vehicle via a drive shaft and an associated drive sprocket. Snowmobiles usually rely on CVTs to transmit the engine's power to the endless track. The CVT may or may not be incorporated integrally as a part of the engine.

PWCs differ from each of the other types of vehicles described above. PWCs typically rely on a jet pump for propulsion. The jet pump includes an impeller disposed within a water tunnel within the hull of the vehicle. The impeller is connected to a drive shaft that is connected to the engine. In most cases, the motive power from the engine is transmitted directly to the impeller without the use of any kind of transmission at all.

In view of these differences, it should not be surprising to learn that the cost associated with designing and manufacturing each vehicle model within a vehicle type is enormous. It is also, to some degree, duplicative of the effort invested in the design of other vehicle models of other vehicle types within the family of recreational vehicles.

It is the area of overlap between vehicle types within a family of recreational vehicles, from a design and manufacturing standpoint, that the prior art is deficient. Any overlap in the design and manufacture of two vehicles within a family of vehicles unnecessarily duplicates costs associated with the design and manufacture of each vehicle and, ultimately, the family of recreational vehicles.

Cost duplication is unnecessarily wasteful. Accordingly, this inefficiency cries out for a solution that the prior art fails to provide.

### SUMMARY OF THE INVENTION

Among other aspects and benefits, the present invention provides a novel engineering and manufacturing methodology for the construction of a family of recreational vehicles.

It is another aspect of the present invention to provide vehicles engineered and manufactured according to that methodology.

The present invention recognizes, among other aspects, that certain parameters in the design and manufacturing of individual vehicles within a family of recreational vehicles are common to all recreational vehicles within that family.

The present invention also recognizes that the areas of commonality can be exploited to reduce the costs associated with the design and manufacture of a family of recreational products by comparison with the design and manufacture of recreational vehicles in the prior art.

In particular, it is one aspect of the present invention to provide a novel methodology for designing and constructing a family of recreational vehicles where a single engine type may be incorporated into each different vehicle type within the family.

It is another aspect of the present invention to provide one from a family of vehicles. The family includes a first land vehicle selected from a group consisting of a motorcycle, a snowmobile, and an all terrain vehicle. The first land vehicle has a V-type engine and a first transmission operatively connected to the V-type engine. The first transmission is a separate component from the engine. The family also includes a second land vehicle selected from the group consisting of a motorcycle, a snowmobile, and an all terrain vehicle. The second land vehicle has the V-type engine and a second transmission operatively connected to the engine. The second transmission is a separate component from the engine. In addition, the second land vehicle is any land vehicle from the group other than that selected for the first land vehicle.

It is another aspect of the present invention to provide one vehicle from a family of vehicles. The family includes a land vehicle being one selected from a group consisting of a motorcycle, a snowmobile, and an all terrain vehicle. The vehicle selected has a V-type engine and a transmission. The family also includes a water vehicle being one selected from a group consisting of a personal watercraft, a boat having an inboard engine, and a boat having an outboard engine. The water vehicle includes the engine selected for the land vehicle.

Other aspects of the present invention will become apparent from the discussion that follows.

### DESCRIPTION OF THE DRAWINGS

Throughout the description of the present invention, reference to common elements will be made using the same reference numbers, in which:

FIG. 1 is a top view schematic illustration of the present invention, which is exemplary of the various embodiments of the present invention;

FIG. 2 is a side view illustration of one V-type engine contemplated for use with the present invention;

FIG. 3 is a side view illustration of a snowmobile according to a first embodiment of the present invention;

FIG. 4 is a top view of a front portion of the snowmobile illustrated in FIG. 3, showing the relative positioning of the engine within the front portion of that snowmobile;

FIG. 5 is a front view of a personal watercraft according to a second embodiment of the present invention, a portion of the watercraft having been removed to illustrate the approximate position of the engine therein;

FIG. 6 is a cross-sectional, side view illustration of a portion of the jet pump propulsion device for the PWC illustrated in FIG. 5;

FIG. 7 is a side view of a motorcycle according to a third embodiment of the present invention, a portion of the motorcycle having been removed to illustrate the approximate position of the engine therein;

FIG. 8 is a side view of an ATV according to a fourth embodiment of the present invention, a portion of the ATV having been removed to illustrate the approximate position of the engine therein; and

FIG. 9 is a side view of a sport boat according to a fifth embodiment of the present invention, a portion of the sport boat having been removed to illustrate the approximate position of the engine therein.

### DESCRIPTION OF EMBODIMENT(S) OF THE INVENTION

The present invention lies in the construction of a family of recreational vehicles encompassing the following vehicle types: motorcycles, ATVs, snowmobiles, PWCs, boats with inboard engines, and boats with outboard engines. In particular, the present invention lies in the understanding that design and manufacturing costs can be significantly reduced if the same engine is shared between individual models of vehicles within the family of recreational vehicles.

As would be understood by those skilled in the art, each of the vehicle types within the family of recreational vehicles differs from one another in several significant ways. Some of the vehicle types operate on land as land vehicles. Others operate on water as water vehicles. Each of the vehicles have different driving and performance characteristics.

For each vehicle type, conventional wisdom teaches that each vehicle model should be designed on an individual basis. In other words, each model should be designed separately to optimize engine speed, torque, and vehicle weight, to list a few of the characteristics considered. While this wisdom is sound, especially where the vehicle manufacturer produces only one of the vehicle types within the family of recreational vehicles, the cost associated with the design and production of a new engine for each vehicle type is enormous.

The development by Bombardier Rotax GmbH of its 653 cc (cubic centimeter displacement) single cylinder (or mono-cylinder) internal combustion engine is one example of the inefficiency associated with this conventional approach. Specifically, the 653 cc engine was developed for use in the BMW® 650 motorcycle. The 653 cc engine incorporates a five-speed manual clutch transmission within the engine crankcase. The engine was modified so that it could also be incorporated into at least one of Bombardier's recreational vehicles, an ATV marketed as the DS 650.

While variations on the engine were successfully included in the design of both the BWMS motorcycle and Bombardier's DS 650 ATV, the engine could not be modified so that it could be applied to any other vehicle type in the family of recreational products. Among other reasons, the remaining vehicle types within the family require a CVT or do not require any transmission at all. Since both of the variations of the 653 cc engine included a five-speed transmission as part of their integral construction, the transmissions from either engine could not be removed so that the engine might enjoy wider applicability to other vehicle types.

Other examples also exist in the prior art of instances where portions of an engine have been used in subsequent variations on a pre-existing engine design for different vehicle models within a vehicle type. For example, the cylinder head from one engine has been modified and used in other, similar engines. For the most part, however, even in instances where some parts manufactured for another engine are used for a new engine model, the new engine will be an entirely new design. Significant research and development efforts are required to create the new engine design.

The present invention recognizes that a single engine type may be designed and manufactured for at least two of the vehicle types within the family of recreational products. Preferably, the single engine would be designed for all of the vehicle types within the family of recreational products.

In particular, the present invention includes the development of and manufacture of an engine without an associated transmission. Without a transmission, the engine is capable of being placed in any of the vehicle types within the family of recreational products. So that the engine may operate in any of the vehicle types, a transmission appropriate for the particular vehicle model within the vehicle type may be manufactured or selected to connect the engine to the vehicle's propulsion device. Designing and manufacturing a new transmission for each vehicle type is less costly than designing and manufacturing a new engine including a suitable transmission, as has been the practice in the past.

As discussed above, for each vehicle type, a different type of transmission connects the engine to the propulsion device. For a motorcycle, a manual, geared, clutch-type transmission typically is used. For an ATV, the transmission typically is a CVT or a manual, geared, clutch-type transmission. Snowmobiles usually rely on a CVT to transmit power from the engine to the endless track that propels the vehicle. In PWCs and boats, the engines typically are connected to the impeller (in the case of a jet pump propulsion system) or the propeller (in the case of an outboard motor) directly, without any transmission at all.

Since the present invention decouples the transmission from the engine in the design and manufacture of the different vehicle types within the family of recreational products, the investment, tooling, and resources required to develop a new vehicle model within one of the vehicle types may be reduced significantly.

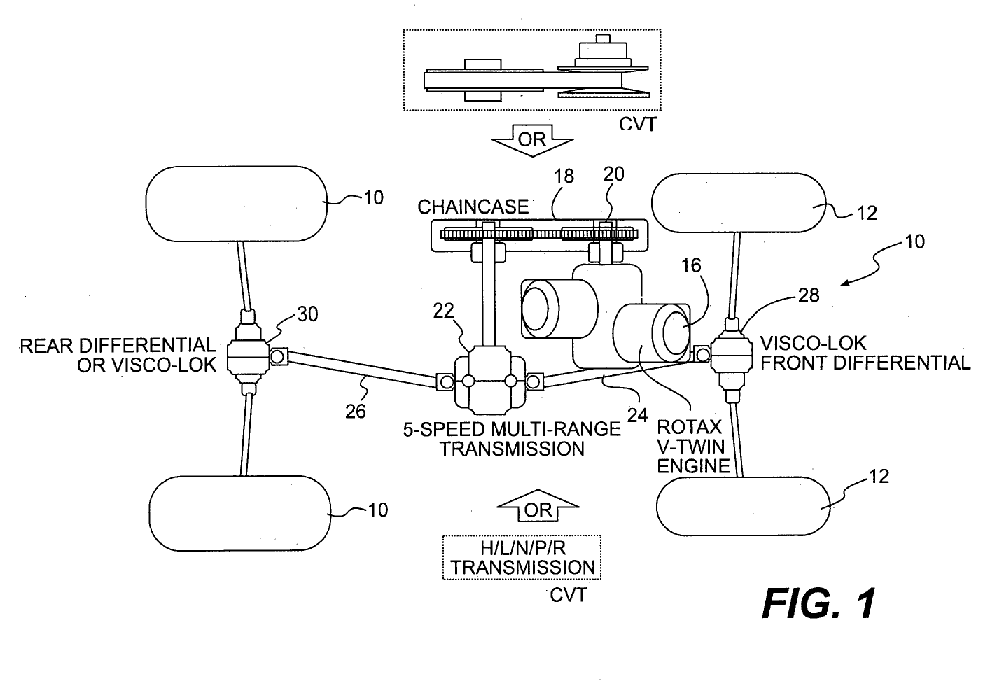

FIG. 1 is a top view schematic illustration of the general concept of the present invention as applied to an ATV 10. While the ATV 10 is used as an example, it is noted that the methodology may be applied to any other of the vehicle types noted herein.

The ATV 10 has two front wheels 12 and two rear wheels 14. An engine 16 is suspended between the front wheels 12 and the rear wheels 14. A chain case 18 operatively connects the output shaft 20 to the engine 16. The chain case 18 houses the endless connector that extends between two rotating shafts so that rotational motion may be transferred from one to the other. The endless connector may be of any suitable type including a chain or a belt, as would be appreciated by those skilled in the art.

The chain within the chain case 18 operatively connects the engine 16 to a separate transmission 22, such as a five-speed multi-range transmission. Alternatively, the transmission could be a CVT or an automatic transmission, for example. In the illustrated embodiment, the transmission is operatively connected to the front wheels 12 via a front drive shaft 24 and to the rear wheels 14 via a rear drive shaft 26. The front drive shaft operatively connects to the front wheels via a front differential 28. Similarly, the rear drive shaft 26 connects to the rear wheels 14 via a rear differential 30. The front and rear differentials 28, 30 may be of any construction as would be known to those skilled in the art.

The engine 16 preferably is a four-stroke, V-type, internal combustion engine. A V-type engine is preferred for several reasons including its power characteristics, vibration characteristics, and the sound that the engine produces during operation. The present invention, however, is not limited solely to a V-type, four-stroke engine. To the contrary, as would be appreciated by those skilled in the art, any other type of engine, including any cylinder arrangement for a two-stroke or four-stroke engine, is also contemplated to fall within the scope of the present invention. Such examples include a W-type engine, a three, four, six, or eight cylinder engine, an in-line engine, and a slant-type engine.

A V-type, four-stroke engine is preferred for use with the present invention because V-type, four-stroke engines may be constructed readily with an engine displacement of greater than 650 cc. As a general rule, consumers prefer engines of 650 cc or more for recreational vehicles because they generate acceptable power outputs for such vehicles. Moreover, when the angle between the pistons for a V-type engine lies in a range between 82 and 90 degrees, no balancer shaft is required for the engine. This means that the engine will be lighter and also that the engine will be less expensive to produce than an engine requiring a balancer shaft. In addition, such a V-type engine is more likely to maximize its power output than an engine that requires a balancer shaft, because the engine will not have the operational losses associated with the inclusion of a balancer shaft. Also, the general public tends to prefer the sound of this type of engine over others available in the marketplace.

While it is contemplated that other engine types also fall within the scope of the present invention, there are certain disadvantages to those engines which discourages their use in the present invention. For example, a four-stroke, single-cylinder engine is limited in the total displacement that the engine offer. The maximum displacement of a single-cylinder, four-stroke engine is approximately 650 cc, which is at the lower limit of engine size desired for use with recreational vehicles. The reason for this limitation is that the size of the single bore and the size of the piston in the bore for larger-sized engines actually impedes optimal operation of the engine due to forces generated during operation of the engine. In fact, it is known, at least to the inventors of the present invention, that for a single-cylinder, four stroke engine created with a displacement of 700 cc, the engine produces a lower power output than the same engine with a 650 cc displacement. A single-cylinder engine also requires a counter balancer (or counter-balance shaft) to counter the forces generated by the piston during its stroke within the cylinder bore. A counter balancer adds to the weight of the engine, complicates the design of the engine, and adds to the cost of designing and manufacturing the engine. In addition, the sound of a single-cylinder, four-stroke engine is not as pleasing to ears of the consuming public.

Recognizing that recreational vehicles typically require an engine with larger than a 650 cc displacement, manufacturers have turned alternatively to either two-stroke, inclined engines or boxer-type engines. There are disadvantages associated with each of these engines as well.

A disadvantage with a two-stroke, inclined engine is that it does not operate as smoothly as a V-type, four-stroke engine. The inclined engine tends to vibrate more than the V-type engine, which has a negative impact both on the operation of the vehicle and on the comfort of the rider. In addition, the engine requires expensive counter balance shafts to reduce vibration associated with its operation. The engine also is considered to be more polluting than V-type, four-stroke engines.

Accordingly, the present invention specifically provides for the construction of multiple vehicles from a family of recreational vehicles where each of the vehicles has a V-type, four-stroke internal combustion engine, such as the engine 16. In addition, the present invention provides for the operative coupling of the engine 16 to a transmission appropriate for the particular vehicle model within the vehicle type. In the case of a PWC, a boat with an inboard engine, and a boat with an outboard engine, the same engine 16 is provided, but the engine 16 does not require any transmission. With this in mind, there are several vehicle types that can be manufactured according to this design and manufacturing methodology.

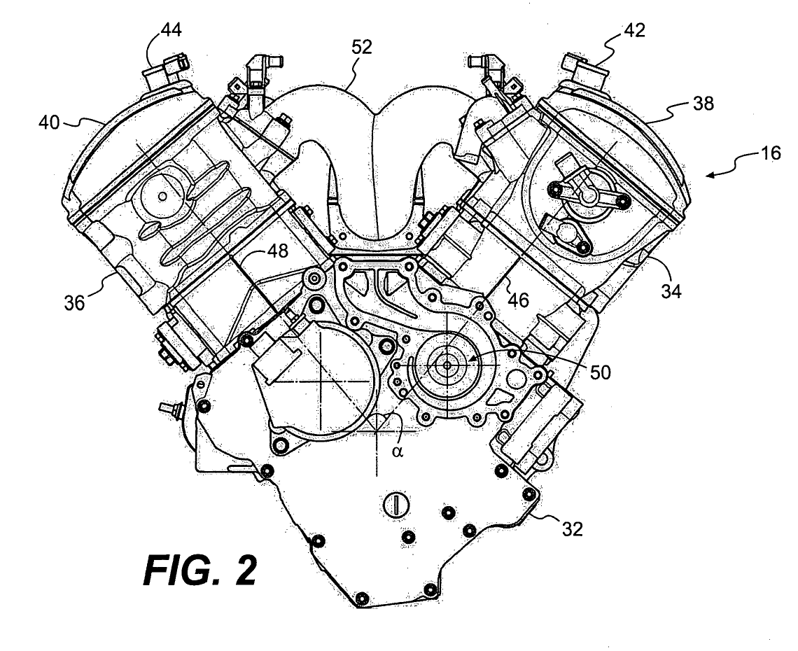

Returning to the drawings, FIG. 2 illustrates a V-type, four-stroke, internal combustion engine 16 of the type contemplated for use with the present invention. The engine 16 includes a crankcase 32. A first cylinder housing 34 and a second cylinder housing 36 are connected to the crankcase 32. The first cylinder housing 34 houses a first piston (not shown) and the second cylinder housing 34 houses a second piston (not shown), both of which reciprocate within their respective housings 34, 36 to generate power. The first cylinder housing 34 is capped with a first cylinder head 38 and the top of the second cylinder housing 36 is capped with a second cylinder head 40. A first spark plug 42 extends into the combustion chamber formed by the first cylinder housing 34 and the first cylinder head 38. A second spark plug 44 extends through the second cylinder head 40 into the combustion chamber formed by the second cylinder housing 36 and the second cylinder head 40.

The first cylinder housing 34 defines a first cylinder axis 46 that extends along the centerline of the cylinder bore therein. Similarly, the second cylinder housing 36 defines a second cylinder axis 48 extending along the centerline of the cylinder bore therein. The first cylinder axis 46 and the second cylinder axis 48 preferably are disposed at an angle a that lies substantially between about 82 and 90 degrees. In FIG. 2, the locations of a water pump 50 and an exhaust manifold 52 also are illustrated.

As discussed above, the engine 16 does not include a transmission. Where the vehicle model requires a transmission, the appropriate transmission may be selected from a variety of types including: a geared transmission, a manual transmission, a continuously variable transmission, or an automatic transmission.

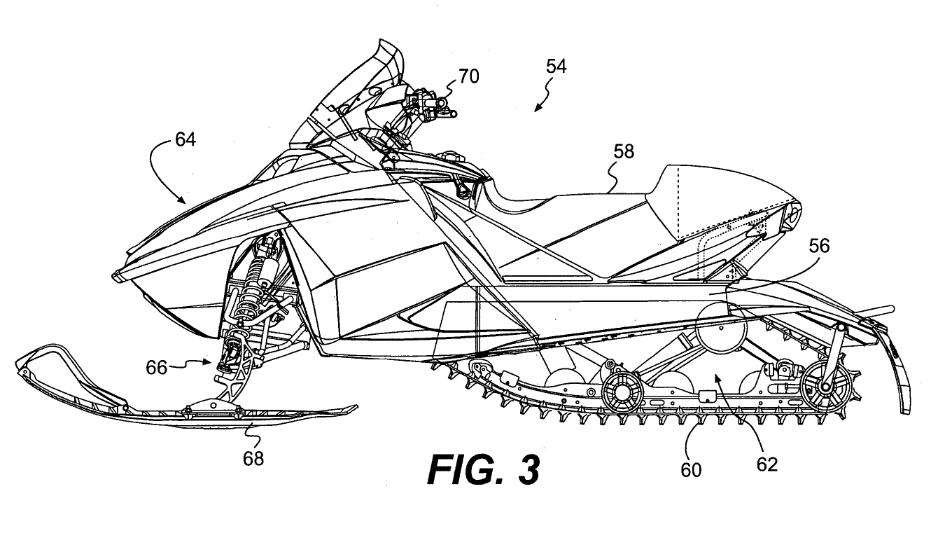

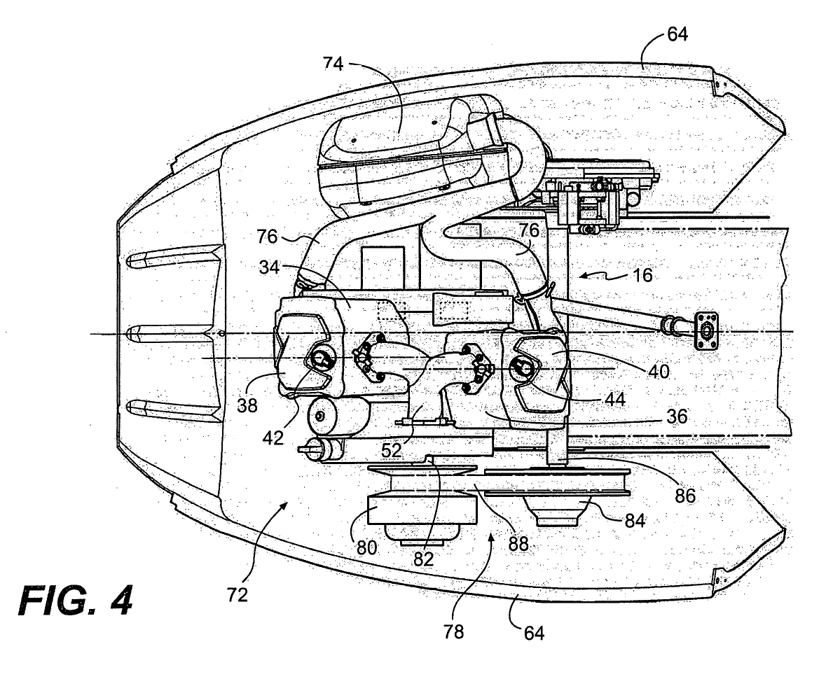

FIG. 3 is a side view of a snowmobile 54 constructed according to the teachings of the present invention. The snowmobile 54 includes a frame 56 onto which a seat 58 is disposed. An endless track 60 travels around a rear suspension 62 to propel the vehicle. The endless track is operatively connected to the engine 16 (shown in FIG. 4) disposed within the front fairings 64 of the snowmobile 54. The snowmobile 54 also includes a front suspension 66 to which two snowmobile skis 68 are attached. The skis 68 are operatively connected to a steering handlebar 70 so that the snowmobile 54 may be steered over ground terrain.

FIG. 4 provides a top view of the approximate position of the engine 16 within an engine compartment 72. The engine compartment 72 is surrounded by the front fairings 64 of the snowmobile 54. An air box 74 is positioned within the engine compartment 72. Intake air is first processed by the air box 74 before it passes through the intake air manifold 76, which directs the intake air to the first and second combustion chambers.

A continuously variable transmission 78 is operatively connected to the engine 16. As would be appreciated by those skilled in the art, a drive pulley 80 is attached to the output shaft 82 of the engine 16. A driven pulley 84 is connected to a drive shaft 86. A belt 88 extends between the drive pulley 80 and the driven pulley 84. The endless track 60 is operatively connected to the drive shaft 86. The drive pulley 80, the driven pulley 84, and the belt 88, which make up the CVT 78, interact with one another in a known manner to transmit power from the engine 16 to the endless track 60.

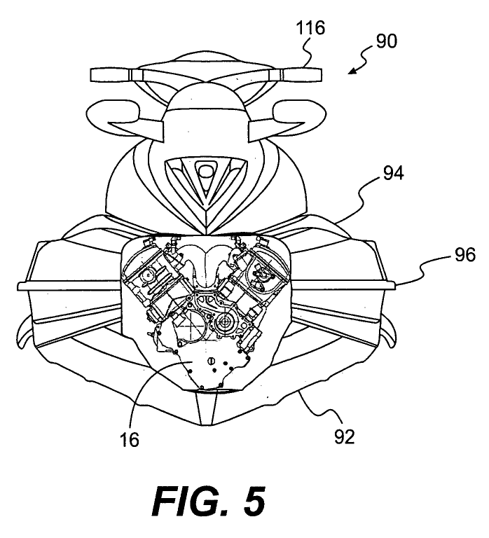

FIG. 5 is a front view of a PWC 90. The PWC 90 has a hull 92 and a deck 94 attached to the hull 92 along a seam 96 that extends around the periphery of the PWC 90. The engine 16 is disposed within the hull 92 of the PWC 90.

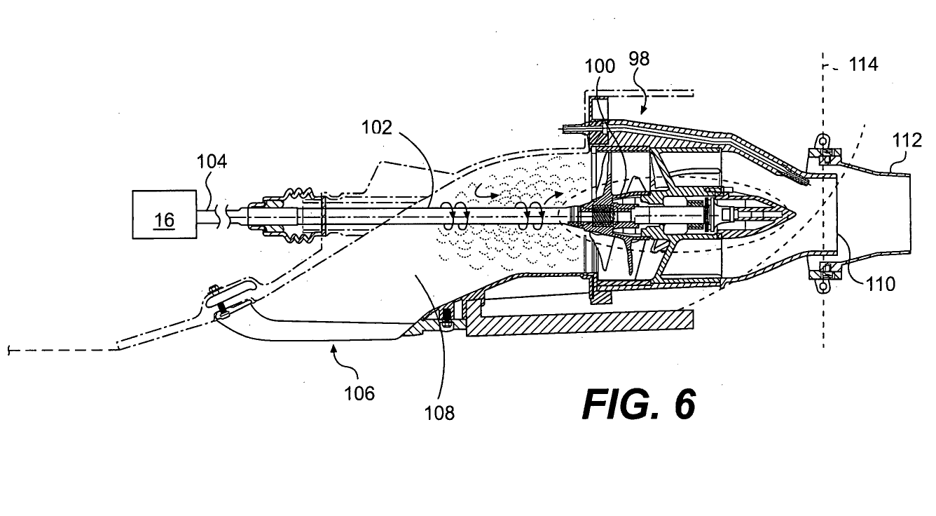

FIG. 6 illustrates a jet pump propulsion assembly 98 incorporated into the watercraft 90 illustrated in FIG. 5. The jet propulsion assembly 98 includes an impeller 100 disposed on an impeller shaft 102. The impeller shaft 102, in turn, is connected to a drive shaft 104, which is operatively connected to the engine 16. No transmission is needed for this connection.

When operating, the impeller 100 sucks water through an inlet port 106 disposed at the bottom, rearward portion of the hull 92. The water passes through a water tunnel 108 and is discharged through a nozzle 110 positioned at the end of the water tunnel 108. A directional nozzle 112 is pivotally connected to the discharge nozzle 110. The directional nozzle pivots 112 about an axis 114. The directional nozzle 112 is connected to the steering handlebar 116 on the PWC 90. As the handlebar 116 is turned, the directional nozzle 112 turns to steer the PWC 90.

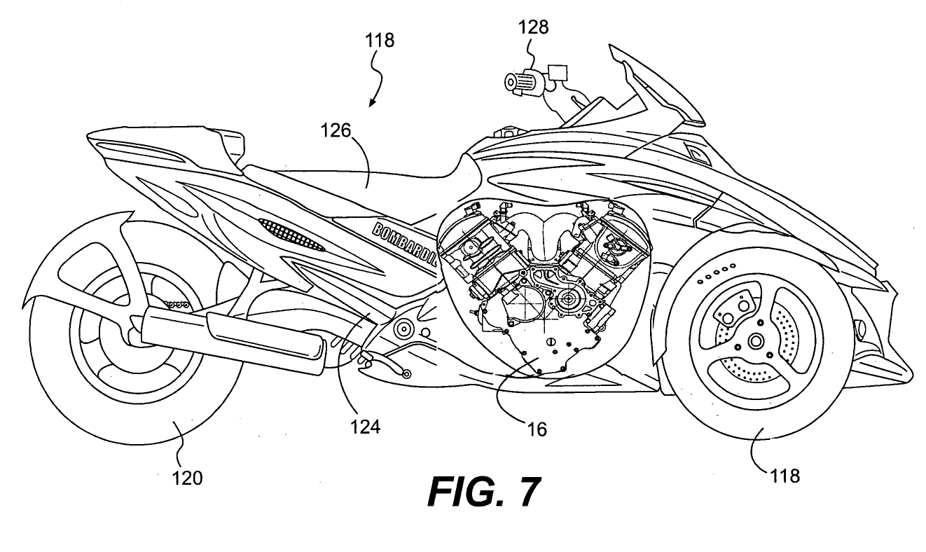

FIG. 7 illustrates a type of motorcycle 118 constructed in accordance with the teachings of the present invention. The motorcycle 118 includes two front wheels 120 and a single rear wheel 122. The motorcycle 118 has a frame 124 on which a seat 126 is disposed to accommodate at least one rider. The motorcycle 118 also has a steering handlebar 128 that is connected to the two front wheels 118 to steer the vehicle. The engine 16 is disposed on the frame 124 at a central location on the motorcycle 118. The engine 16 is operatively connected to the rear wheel 120 to propel the vehicle. As is common for motorcycles, the engine 16 transmits power to the rear wheel 120 via a manually-operated, clutch-type, geared transmission. However, among other options, a CVT or automatic transmission could be substituted therefor without deviating from the scope of the present invention.

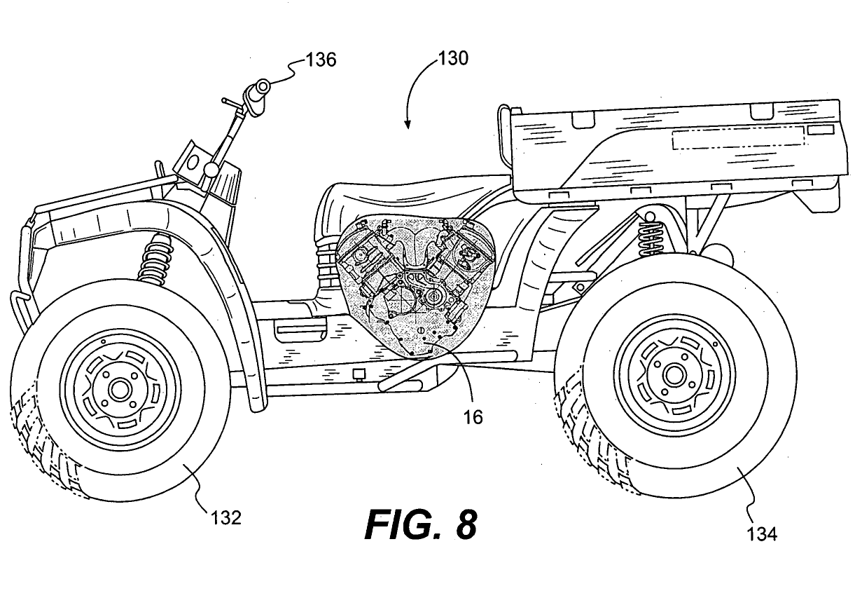

FIG. 8 is a side view of an ATV 130 constructed in accordance with the teachings of the present invention. The ATV 130 includes two front wheels 132 and two rear wheels 134. The front wheels 132 are operatively connected to the steering handlebar 136 so that the ATV 130 may be steered. The engine 16 is disposed at a central location on the ATV 130, as shown. The engine 16 is operatively connected to either or both of the front and rear wheels 132, 134 in the manner illustrated and described in connection with FIG. 1. As discussed, the transmission for the ATV 130 may be a manually-operated, clutch-type, geared transmission. However, as with the motorcycle 118, a CVT or automatic transmission could be substituted therefor without deviating from the scope of the present invention.

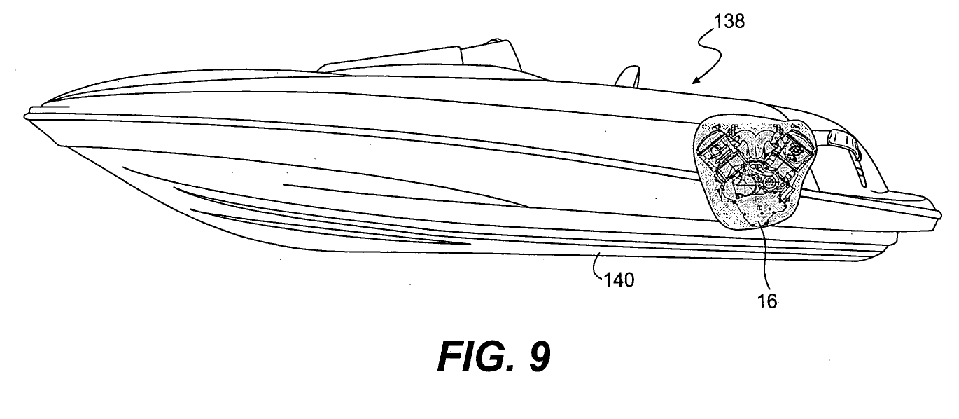

FIG. 9 is a side view of a sport boat 138 with the engine 16 disposed at a rearward location within the boat's hull 140. The sport boat 138 is jet propelled and may rely on a jet propulsion assembly 98 illustrated in FIG. 6 for its propulsion or on a variation of the jet propulsion assembly 98 shown and described. As with the PWC 90, no transmission is required to transfer motive force from the engine 16 to the impeller.

In each of the embodiments of the present invention, the engine 16 is the primary repeating component. The transmission is a separate component selected for the particular vehicle type being designed and manufactured. As discussed above, designing and manufacturing a family of recreational vehicles that can accept the same engine greatly reduces the cost associated with the design and manufacture of that family of recreational vehicles.

The embodiments of the present invention that are described above are meant to be illustrative of the present invention only. The embodiments illustrated and described are not meant to limit the present invention solely to the embodiments described. To the contrary, the embodiments are meant to illustrate the breadth of the scope of the present invention. Those skilled in the art would readily appreciate the unlimited potential of the present invention.

1. One from a family of vehicles, the family comprising:
a first land vehicle selected from a group consisting of a motorcycle, a snowmobile, and an all terrain vehicle, the first land vehicle comprising
a V-type engine, and
a first transmission operatively connected thereto,
wherein the first transmission is a separate component from the engine; and
a second land vehicle selected from the group consisting of a motorcycle, a snowmobile, and an all terrain vehicle, the second land vehicle comprising
the V-type engine, and
a second transmission operatively connected thereto,
wherein the second transmission is a separate component from the engine; and
wherein the second land vehicle is any land vehicle from the group other than that selected for the first land vehicle.

2. The vehicle of claim 1, wherein:
the first transmission is one selected from a group comprising a geared transmission, a manual transmission, a continuously variable transmission, or an automatic transmission.

3. The vehicle of claim 2, further comprising:
an endless connector operatively connecting the engine to the first transmission.

4. The vehicle of claim 3, wherein:
the endless connector is selected from a group comprising a chain and a belt.

5. The vehicle of claim 1, wherein:
the second transmission is one selected from a group comprising a geared transmission, a manual transmission, a continuously variable transmission, or an automatic transmission.

6. The vehicle of claim 5, further comprising:
an endless connector operatively connecting the engine to the first transmission.

7. The vehicle of claim 6, wherein:
the endless connector is selected from a group comprising a chain and a belt.

8. The vehicle of claim 1, wherein:
the V-type engine has a displacement of at least 650 cubic centimeters.

9. The vehicle of claim 8, wherein:
the V-type engine comprises two cylinder bores, the axes of which are disposed relative to one another at an angle of between about 82 and 90 degrees.

10. One vehicle from a family of vehicles, the family comprising:
a land vehicle being one selected from a group consisting of a motorcycle, a snowmobile, and an all terrain vehicle, the land vehicle comprising
a V-type engine, and
a transmission operatively connected thereto; and
a water vehicle being one selected from a group consisting of a personal watercraft, a boat having an inboard engine, and a boat having an outboard engine, the water vehicle comprising the engine.

11. The vehicle of claim 10, wherein:
the transmission is one selected from a group comprising a geared transmission, a manual transmission, a continuously variable transmission, or an automatic transmission.

12. The vehicle of claim 11, further comprising:
an endless connector operatively connecting the engine to the transmission.

13. The vehicle of claim 12, wherein:
the endless connector is selected from a group comprising a chain and a belt.

14. The vehicle of claim 10, wherein:
the V-type engine has a displacement of at least 650 cubic centimeters.

15. The vehicle of claim 14, wherein:
the V-type engine comprises two cylinder bores, the axes of which are disposed relative to one another at an angle of between about 82 and 90 degrees.
